(19) United States
(12) Patent Application Publication
(10) Pub. No.: US 2026/0271886 A1
(43) Pub. Date: Sep. 17, 2026

(54) MODULAR ANIMAL-MOUNTED CONTAINER DISTRIBUTION SYSTEM

(71) Applicants: Maria Coleman, West Chester, PA (US); Michael Coleman, Seminole, FL (US)

(72) Inventors: Maria Coleman, West Chester, PA (US); Michael Coleman, Seminole, FL (US)

(21) Appl. No.: 19/682,409

(22) Filed: May 19, 2026

Related U.S. Application Data
(60) Provisional application No. 63/808,616, filed on May 19, 2025.

(51) Int. Cl. A01K 27/00

(52) U.S. Cl. CPC A01K 27/008; A01K 27/002

(57) ABSTRACT

An animal-mounted container distribution system comprises an animal-worn support structure secured to an animal and a plurality of resilient engagement members mounted along at least one lateral region thereof. Each resilient engagement member comprises a resilient body defining an open gap and a curved receiving region configured to flex or deflect upon insertion of a portion of a container and return to partially encircle and releasably retain the container portion in an exposed position in which at least a portion of the container is visible and manually graspable without opening a flap, cover, closure, pouch, pocket, or enclosure. The engagement members are mounted along rigid or semi-rigid support members, with upper and lower support members on each lateral side interconnected by flexible coupling members. An adjustable strap suspension mechanism permits tool-free vertical adjustment and selective removal of the lower support member. Modular decorative panels are interchangeable with the container assembly.

### CROSS-REFERENCE TO RELATED APPLICATIONS

This application claims the benefit of U.S. Provisional Patent Application No. 63/808,616, filed May 19, 2025, the entire disclosure of which is incorporated herein by reference.

### FIELD OF THE INVENTION

The disclosed technology relates to wearable accessories for animals, and more particularly to animal-mounted systems for releasably retaining and distributing a plurality of containers for individual access by persons at events and gatherings. Although the term “harness” is used throughout this specification for convenience, the disclosed container distribution assembly may be mounted to, carried by, or integrated with a wearable harness, saddle structure, saddle rigging, animal pack, vest, blanket, cape, or other animal-worn support structure. In some embodiments, the containers include cylindrical or generally cylindrical containers, such as miniature liquor bottles, beverage cans, cosmetic sample tubes, or promotional product containers.

### BACKGROUND OF THE INVENTION

Animals have long participated in human social events and ceremonies, including weddings, festivals, and promotional gatherings. Dogs, goats, miniature horses, donkeys, and horses are commonly present at such events and naturally draw the attention and affection of guests. Known commercially available animal harness accessories do not provide a functional mobile distribution platform for individual containers, including by way of example 50 mL liquor bottles (commonly known as “shooters”), beverage cans, cosmetic sample containers, or promotional product containers.

Existing animal-worn accessories, including pouches, utility packs, and carry bags, generally retain carried articles within enclosed or semi-enclosed compartments. Such arrangements may reduce visibility of individual items and may require a handler or wearer to open a pouch, flap, zipper, or other closure before a selected item can be accessed. For event and promotional settings, there is a need for an animal-mounted system that visibly presents individual containers for selective manual removal while the animal-worn support remains secured to the animal.

For example, at a wedding event, it is desirable for a dog to walk among cocktail-hour guests distributing individual liquor shooters from its harness, and then—after a rapid accessory swap—serve as the ring bearer or flower girl by carrying a wedding ring box or artificial flowers during the ceremony. Known commercially available animal harness accessories do not provide this combination of exposed container distribution and rapid decorative reconfiguration.

A need exists, therefore, for an animal-mounted system that: (1) retains a plurality of containers in exposed positions in which at least a portion of each container is visible and manually graspable without opening a flap, cover, closure, pouch, pocket, or enclosure; (2) distributes container weight across an animal's body; (3) allows selective individual removal of a single container without disturbing remaining containers or unfastening the animal-worn support structure; (4) accommodates the curved dorsal and lateral contours of different animal body sizes; (5) is modular and reconfigurable for decorative or branding applications; and (6) allows interchange of functional and decorative modules without removing the base animal-worn support structure from the animal. Furthermore, prior art animal-worn accessories that must be removed and replaced to transition between functional configurations create a period during which the animal has no secured harness and no attached leash—an unacceptable safety risk in crowded event environments.

Unlike human-worn vending platforms, tool belts, or bottle holders, an animal-mounted distribution system must accommodate animal gait, curved and moving body contours, handler control, guest approach from different directions, and safety release under accidental impact or snagging. A rigid or semi-rigid container support must therefore cooperate with flexible harness or saddle attachment regions to maintain container visibility and access while reducing asymmetric loading, swinging, rotation, and pressure points on the animal.

The disclosed system addresses the technical challenge of presenting multiple containers on an animal-worn platform in a manner that keeps individual containers visible, manually accessible, and releasably retained during ordinary animal movement. In embodiments, this is accomplished through exposed resilient engagement members having open gaps and curved receiving regions, rigid or semi-rigid support members, adjustable attachment structures, and modular components that can be exchanged while the animal-worn support structure remains secured to the animal. In some embodiments, the engagement structures are cylindrical, generally cylindrical, partial-annular, C-shaped, U-shaped, opposed-arm, or otherwise shaped to engage a corresponding portion of a retained container.

### SUMMARY OF THE INVENTION

In embodiments, an animal-mounted container distribution system comprises a wearable harness secured to an animal and a plurality of resilient engagement members that releasably retain portions of containers in exposed positions in which at least a portion of each container is visible and manually graspable without opening a flap, cover, closure, pouch, pocket, or enclosure. In alternative embodiments, the container distribution assembly is mounted to or incorporated with a saddle structure, saddle rigging, animal pack, vest, blanket, cape, or other animal-worn support structure without departing from the disclosed technology.

The containers retained and distributed by the disclosed system may include beverage bottles and cans (liquor shooters, energy drinks, water bottles), cosmetic containers (mascara tubes, lipstick tubes, perfume rollerballs), pharmaceutical containers, writing implements (pens, markers, highlighters), promotional product tubes, or other objects suitable for individual distribution at events or activities. In some embodiments, a retained container has a cylindrical or generally cylindrical portion, such as a neck, cap, shoulder, sidewall, body portion, tube portion, or can wall, that is received and gripped by an engagement member. In other embodiments, the container may have an oval, flattened, tapered, irregular, or rounded-rectangular portion that is releasably retained by resilient engagement members having sufficient spring compliance. The resilient engagement members are dimensioned and configured to accommodate a range of container sizes, shapes, diameters, widths, and materials, enabling versatile use across multiple distribution applications and industries.

In one aspect, the disclosed system provides resilient engagement members, each comprising a resilient body defining an open gap and a curved receiving region configured to flex or deflect upon insertion of a portion of a container and to spring back or return to partially encircle and releasably retain that portion of the container. In certain embodiments, the resilient engagement member is a partial-cylindrical or partial-annular clip defining an open radial gap. This resilient engagement permits a guest to insert a container with a single motion and withdraw it with a single pull, without tools or handler assistance.

In another aspect, the disclosed system includes a rigid or semi-rigid support member mounted to the harness, extending generally parallel to the animal's longitudinal axis, with an array of container engagement members mounted along its length. This structural platform distributes container weight along the animal's lateral surface and maintains container alignment. The support member may include one or more longitudinal members, rails, bars, strips, plates, molded panels, semi-rigid polymer bodies, or integrated assemblies. The support member may be secured to the harness by at least one fastener, including a removable fastener, a permanent fastener, or a combination thereof. Examples include hook-and-loop fasteners, straps, buckles, mechanical fasteners, snap buttons, clips, quick-release systems, sewing, stitching, riveting, welding, gluing, adhesive bonding, integral molding, or other attachment structures.

In a further aspect, upper and lower support members, such as rigid longitudinal support members, on each lateral side of the harness are interconnected by flexible coupling members, forming a hybrid rigid-flex dorsal support assembly that conforms to the animal's body contour while providing structural support for the container array.

In yet another aspect, a lower support member is suspended from an upper support member by flexible straps threaded through slide buckles, permitting tool-free vertical adjustment and selective removal of the lower row.

The system is further configurable with modular decorative panels, branding surfaces, and interchangeable engagement modules, enabling rapid transformation between a container-serving configuration and a decorative or ceremonial configuration.

The disclosed system is operable with dogs, goats, miniature horses, donkeys, horses, and other harness-capable animals, and is compatible with commercially available adjustable harnesses, saddle structures, saddle riggings, animal packs, vests, blankets, capes, or other animal-worn support structures.

### BRIEF DESCRIPTION OF THE DRAWINGS

The accompanying drawings, which are incorporated herein and form part of the specification, illustrate preferred embodiments of the disclosed technology. Together with the description, the drawings serve to explain the principles of the disclosed technology.

FIG. 1 is a perspective view of an animal-mounted container distribution system according to a preferred embodiment, shown in use on an animal (A) wearing an animal-worn support structure (20) with a container distribution assembly (30) comprising upper and lower support members (40u, 40l) carrying resilient engagement members (50a) retaining containers (C), secured by chest strap (28a) and belly strap (28b).

FIG. 2 is a plan view of the bilateral container distribution assembly laid flat, showing the longitudinal axis (L), upper (40u) and lower (40l) support members on each lateral side, resilient engagement members (50a), webbing straps (60w), adjustable dorsal cross-strap (68), mechanical buckles (84), and dorsal center buckle (84d), illustrating two independent fit adjustments: lateral width adjustment across the animal's back by changing the effective length of the dorsal cross-strap (68), and vertical row-spacing adjustment on each lateral side by repositioning the upper and lower support members (40u, 40l) along the webbing straps (60w) and mechanical buckles (84).

FIG. 3 is a perspective view of the system in the four-row configuration, showing the animal-worn support structure (20), the container distribution assembly (30), upper (40u) and lower (40l) support members on each lateral side carrying resilient engagement members (50a), and hook-and-loop fastening strap (60b).

FIG. 4 is an exploded perspective view of the support member fastening assembly showing the rigid support member (40), resilient engagement members (50a), mechanical fasteners (56), lower fastening strap (60a), upper fastening strap (60b), and the hook-and-loop receiving surface (26) of the animal-worn support structure.

FIG. 5 is three sequential views of a single resilient engagement member (50a): the top view shows the contracted natural state with open gap (54) visible; the middle view shows the expanded state upon insertion of a portion of a container (C) into the curved receiving region (53); and the bottom view shows the contracted retention state with resilient body (52) partially encircling the container, and a rotation indicator showing the container is rotatable within the engagement member.

FIG. 6 is a perspective view of the system in the two-row configuration, showing the animal-worn support structure (20) and a single support member (40) per lateral side carrying resilient engagement members (50a), wherein an adjustable suspension strap (82) provides tool-free vertical height adjustment of the support member (40) relative to the harness.

FIG. 7 is a perspective view of the animal-worn support structure (20) in a modular decorative or event configuration, showing a representative decorative panel assembly (100) with a floral integration panel (104), branding surface (106), and tip jar mount (112) attached to the harness, and illustrating the system's capacity to interchangeably receive additional modular components including a wedding panel (102), LED integration panel (108), and ring bearer panel (110), demonstrating rapid modular reconfiguration without removing the animal-worn support structure from the animal.

FIG. 8 is a cross-sectional view of the support member (40) and resilient engagement members (50a) formed as an integrally molded or cast single non-separable unit, showing the continuous material structure from the support member body into the engagement members.

FIG. 9 is an elevation view of the support member (40) carrying a plurality of resilient engagement members (50a) of differing internal dimensions, illustrating an array of larger and smaller clips configured to releasably retain containers of differing outer diameters.

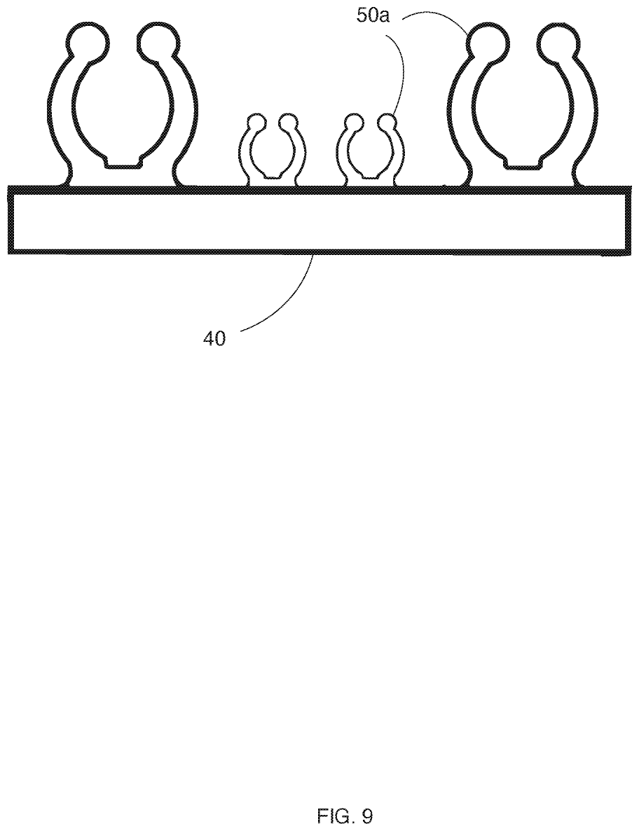

FIG. 10 is a rear elevation view of an animal (A) wearing the animal-worn support structure having rigid receptacles (50b) mounted on support members (40) on opposing lateral sides of the animal.

### DETAILED DESCRIPTION OF THE INVENTION

The following description is of the best mode presently contemplated for carrying out the disclosed technology. The description is not to be taken in a limiting sense but is made merely for the purpose of describing general principles. The scope is best defined by the appended claims.

The drawings are schematic and are provided to illustrate selected embodiments and relationships among components. The illustrated relative sizes, spacings, orientations, and numbers of components may be varied unless expressly recited in a claim. Features shown in separate figures may be combined in a single embodiment, and features described in the specification may be illustrated in corrected, replacement, or additional drawing views without departing from the disclosed subject matter. Reference numerals for elements 44 (radiused or chamfered longitudinal edges), 64 (secondary attachment feature), 90 (wrap clamp straps), and 92 (foam or elastomeric padding layer) are described in the specification without being separately illustrated in the drawings.

### I. Overview

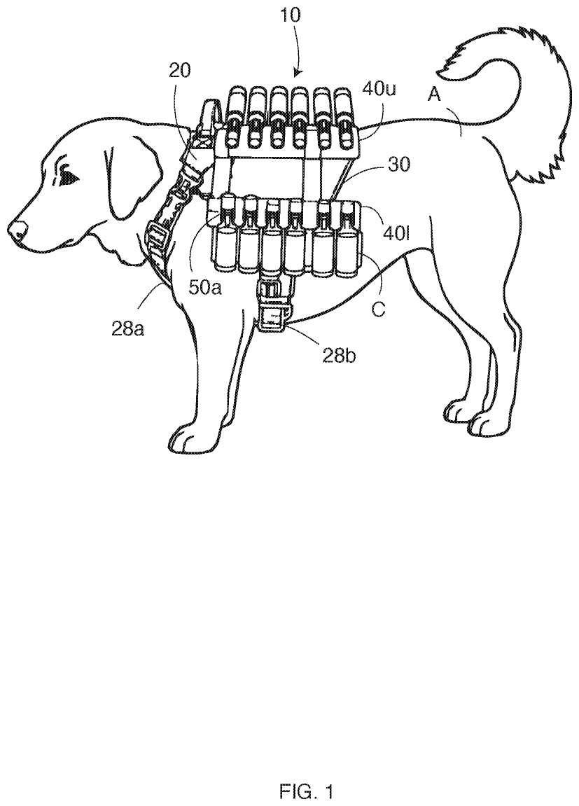

Referring generally to FIGS. 1-3, the animal-mounted container distribution system 10 comprises a wearable harness 20 configured to be secured to an animal A, and a container distribution assembly 30 mounted to the harness 20. The container distribution assembly 30 comprises at least one support structure 40, also referred to herein as a support member, such as a rigid longitudinal support member, and a plurality of container engagement members 50 mounted along the length of the support structure 40. Each container engagement member 50 is configured to releasably retain a portion of a container C in an exposed position in which at least a portion of the container C is visible and manually graspable without opening a flap, cover, closure, pouch, pocket, or enclosure. As used herein, references to mounting the container distribution assembly 30 to the harness 20 include mounting the assembly to any animal-worn structure suitable for supporting the assembly on the animal A, including a wearable harness, saddle structure, saddle rigging, animal pack, vest, blanket, cape, or other support garment. The harness 20 is the preferred animal-worn support structure in the illustrated embodiments, but the disclosed technology is directed to the container distribution assembly and its attachment to the animal-worn support structure rather than to any particular harness or saddle design.

Terms such as “upper,” “lower,” “lateral,” “dorsal,” “inward,” “outward,” “vertical,” and “longitudinal” are used with reference to the animal A and the harness 20 when the harness is worn in a normal use position. These terms are descriptive rather than limiting, and do not require exact geometric alignment. Containers may be retained in upward-facing, downward-facing, sideways-facing, angled, alternating, or other orientations so long as the containers are exposed and manually removable.

In the preferred embodiment shown in FIGS. 1-3, the animal A is a dog. However, it will be appreciated that the system 10 is equally applicable to goats, miniature horses, donkeys, horses, and any other animal capable of wearing a harness. Harness dimensions and attachment configurations are adapted to the specific animal species and body size.

The containers C shown in the preferred embodiment are 50 mL liquor “shooter” bottles. It will be appreciated that the system 10 is compatible with containers of appropriate size and shape, including containers having cylindrical or generally cylindrical portions, standard beverage cans, cosmetic sample tubes, promotional product containers, and other items.

### Definitions

As used herein, “resilient” refers to a material or structure capable of elastically flexing or deflecting in response to insertion or withdrawal of a container and thereafter returning at least partially toward an original or retention configuration so as to releasably grip a portion of the container. The term does not require any particular material, cycle life, spring constant, or degree of deformation, unless expressly recited in a claim.

The resilient engagement members 50 may be constructed from a variety of materials exhibiting spring-back characteristics, including but not limited to: spring steel, stainless steel, titanium alloys, tempered metal alloys, stamped metal, bent sheet metal, wire-form metal, elastomeric polymers (such as rubber or neoprene), thermoplastic elastomers, silicone composites, reinforced polymer blends, or other materials capable of elastic deformation and recovery under the stress conditions of container insertion and withdrawal. The selection of material is dependent on the intended application, desired container size or shape, retention force, animal size, and activity level.

### II. Harness 20

The wearable harness 20 is a commercially available or custom-fabricated body harness sized and configured for the animal A. In some embodiments, the harness 20 is constructed from heavy-duty nylon webbing with breathable padding and is adjustable for different body sizes via buckle and strap adjustments. The harness 20 includes a dorsal panel 22 extending along the animal's back and bilateral lateral panels 24a, 24b extending along the animal's sides. In preferred embodiments, the dorsal panel 22 and lateral panels 24a, 24b include hook-and-loop receiving surfaces 26 (e.g., loop-face hook-and-loop material) to which corresponding hook-face surfaces of the container distribution assembly 30 are releasably attached.

The harness 20 is secured to the animal A by a chest strap 28a passing around the animal's chest and a belly strap 28b passing beneath the animal's abdomen, each strap having a buckle or clip fastener. The harness 20 distributes loads across the animal's torso, avoiding pressure on the spine or sensitive areas.

Nothing herein limits the disclosed system to use with any particular commercially available harness. The container distribution assembly 30 may be adapted for attachment to any harness, saddle structure, saddle rigging, animal pack, vest, blanket, cape, or other animal-worn support structure, including those using different fastening mechanisms.

### III. Rigid or Semi-rigid Support Structure or Support Member 40

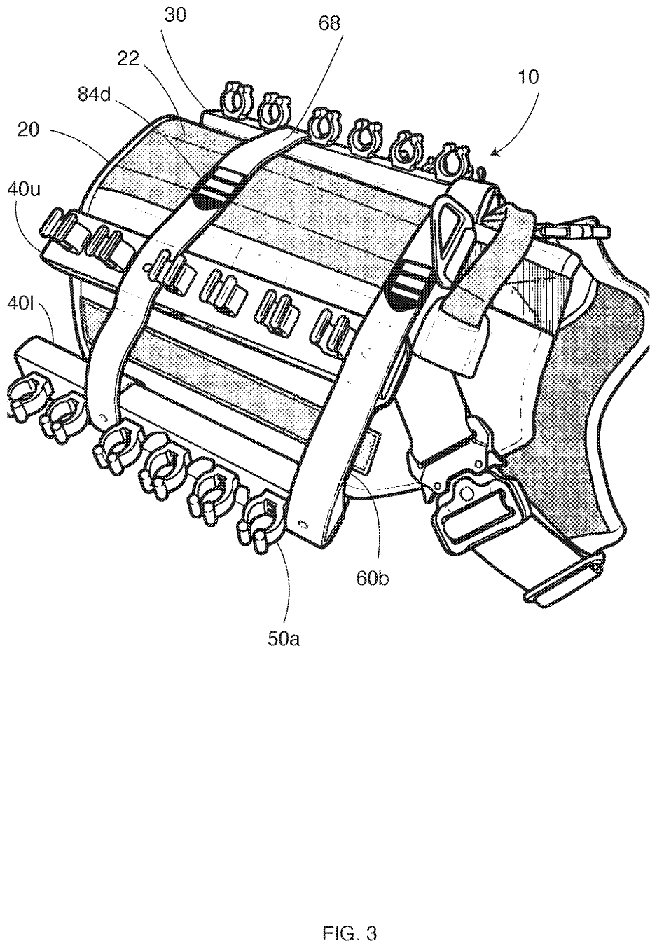

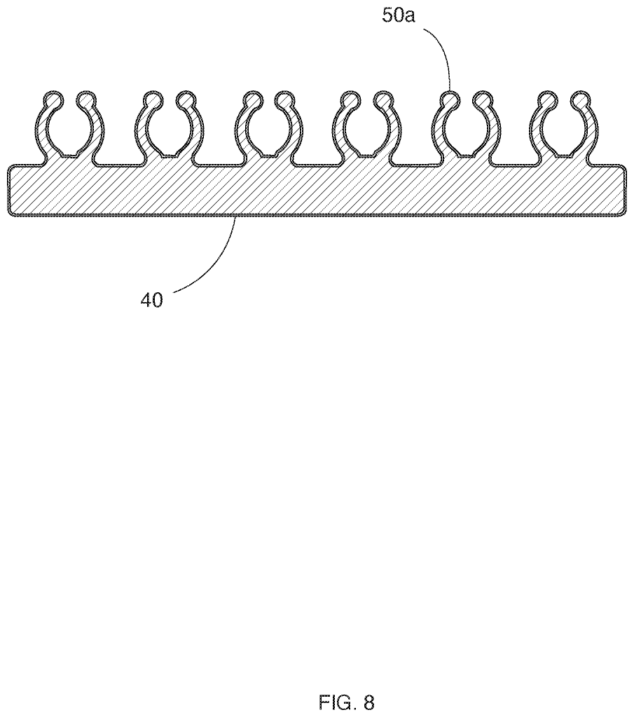

Referring to FIGS. 3-4 and 8, the container distribution assembly 30 includes at least one rigid or semi-rigid support structure 40, also referred to as a support member. In the illustrated embodiments, the support structure 40 is a rigid longitudinal support member. The support structure 40 is an elongated, substantially rigid or semi-rigid structure sized to extend along one lateral region of the harness 20 generally parallel to the longitudinal axis L of the harness 20 (i.e., generally parallel to the animal's spine direction along the side of the body).

In one illustrated embodiment, the rigid longitudinal support member 40 is a painted 1×2 inch wooden strip of approximately 10 inches in length. The broad face 42 of the rigid longitudinal support member 40 contacts the lateral panel 24 of the harness 20, providing a large contact area that stabilizes the support member against rotation and rocking. However, the disclosed technology is not limited to wood or to a separate strip. In alternative embodiments, the support structure 40 may be formed from injection-molded polymer, semi-rigid polymer, extruded aluminum, fiber-reinforced composite, leather, laminated fabric, molded elastomer with sufficient shape retention, or any other material providing sufficient rigidity or semi-rigidity to support the weight of multiple loaded container engagement members 50. The support structure 40 may be a longitudinal member, rail, bar, strip, plate, molded panel, semi-rigid body, or integrated assembly.

In a preferred embodiment, the support structure 40 has edges 44 that are radiused or chamfered to prevent discomfort to the animal A and to avoid abrasion of the harness material.

### A. Attachment to Harness

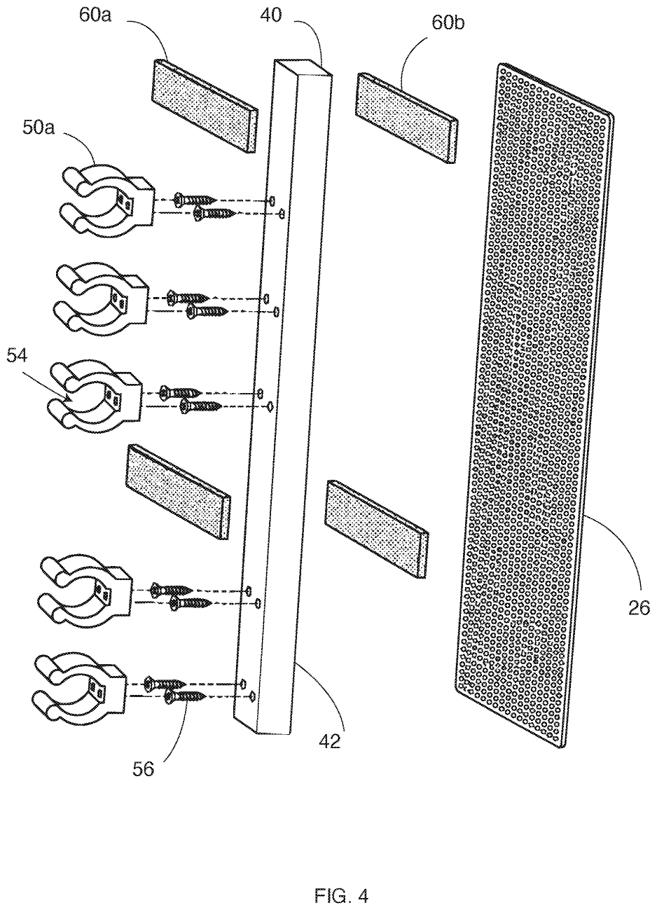

The support structure 40 is secured to the lateral panel 24 of the harness 20 by a fastening system. In the preferred embodiment shown in FIG. 4, at least two fastening positions are used—one near each end of the support structure 40—to prevent tilting or rotation. At each fastening position, a pair of hook-and-loop straps 60 is employed: a lower strap 60a positioned between the hook-and-loop receiving surface 26 of the harness 20 and the underside of the support structure 40, and an upper strap 60b positioned over the top face of the support structure 40. The lower and upper straps 60a, 60b are pressed together, sandwiching the support structure 40 between them and forming a bonded hook-and-loop assembly. Mechanical fasteners 56 (e.g., wood screws or machine screws) are inserted through the upper strap 60b and into the support structure 40 to prevent lateral sliding or rotation of the support structure relative to the straps. The lower face of the lower strap 60a engages with the hook-and-loop receiving surface 26 of the harness 20, securing the entire assembly to the harness. The same attachment principles may be used to secure the support structure 40 to a saddle structure, saddle rigging, animal pack, or other animal-worn support structure.

Suitable fastening systems include hook-and-loop fasteners, snaps, buckles, quick-release clips, screws, bolts, rivets, adhesive bonds, clamps, slots, loops, MOLLE-style webbing, elastic sleeves, zip ties, magnetic fasteners, mechanical latches, sewn seams, stitched pockets, other removable or permanent fasteners, or combinations thereof.

In a preferred arrangement, the support structure 40 further includes a stabilization pad 62 on its harness-facing surface, the stabilization pad 62 comprising a high-friction material (e.g., rubberized foam, silicone sheet, or hook-face hook-and-loop material). The stabilization pad 62 increases frictional resistance between the support structure 40 and the harness 20, further reducing the risk of rotation or lateral sliding.

In embodiments where greater anti-rotation security is desired, the support structure 40 may include a secondary attachment feature 64, such as a protruding tab or loop, that engages a complementary feature of the harness 20 (such as a D-ring, slot, or sewn loop) to mechanically resist rotation. The support structure 40 is removably secured to the harness 20 by the hook-and-loop fastening system, enabling removal and reattachment without tools. In alternative embodiments, the support structure 40 may be permanently attached (e.g., sewn, riveted, bonded, molded, or stitched) to a dedicated harness panel, saddle component, saddle blanket, pack panel, or other animal-worn support structure.

### B. Bilateral Configuration

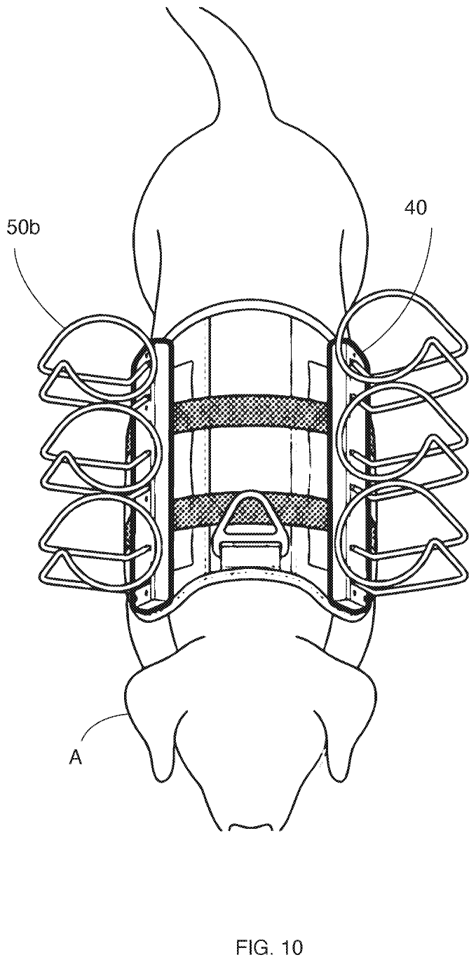

As shown in FIGS. 1-2 and 10, the system 10 preferably includes support structures 40 on both the first lateral side (lateral panel 24a) and the second lateral side (lateral panel 24b) of the harness 20. The bilateral disposition distributes container weight symmetrically, preventing the harness from listing to one side and maintaining the animal's comfort and gait.

### C. Flexible Strap and Buckle Attachment System

In another embodiment, the support structure 40 is secured to the harness 20 via one or more flexible straps 60w, each flexible strap 60w having one or more mechanical buckles 84 positioned along its length. In preferred embodiments, the buckles 84 are heavy-duty slide buckles or cam buckles rated for repeated load cycling. The flexible strap 60w is threaded through the buckle 84, which locks the strap at a selected position when released and unlocks it when the buckle lever or cam is actuated.

This strap-and-buckle attachment configuration provides operational advantages in three respects. First, where a first support structure 40u and a second support structure 40l are both attached to the harness 20 via flexible straps 60w and buckles 84, the vertical spacing between the first and second support structures is set by the locked position of the flexible strap 60w through the buckle 84, and is adjustable by repositioning the strap without removing the harness 20 from the animal A. Second, an entire support structure 40 together with its mounted container engagement members 50 can be removed and exchanged for a different assembly by actuating the buckle 84 to release the flexible strap 60w and re-threading a replacement assembly, without structural modification to the harness 20. Third, support structure assemblies bearing different clip types, clip dimensions, or clip row configurations can be interchanged using the same base harness 20 and strap-and-buckle connector system.

The flexible strap 60w may be constructed from any flexible material suitable for threading through a mechanical buckle, including but not limited to nylon webbing, polyester webbing, leather, synthetic leather, canvas, cotton webbing, elastic material, cord, or combinations thereof, in any suitable width. The buckle 84 may be a three-bar slide buckle, a cam buckle, a ratchet buckle, or any mechanical fastener configured to lock the strap at a selected position without tools and to release the strap upon actuation.

### D. Lateral Width Adjustment via Dorsal Cross-strap 68

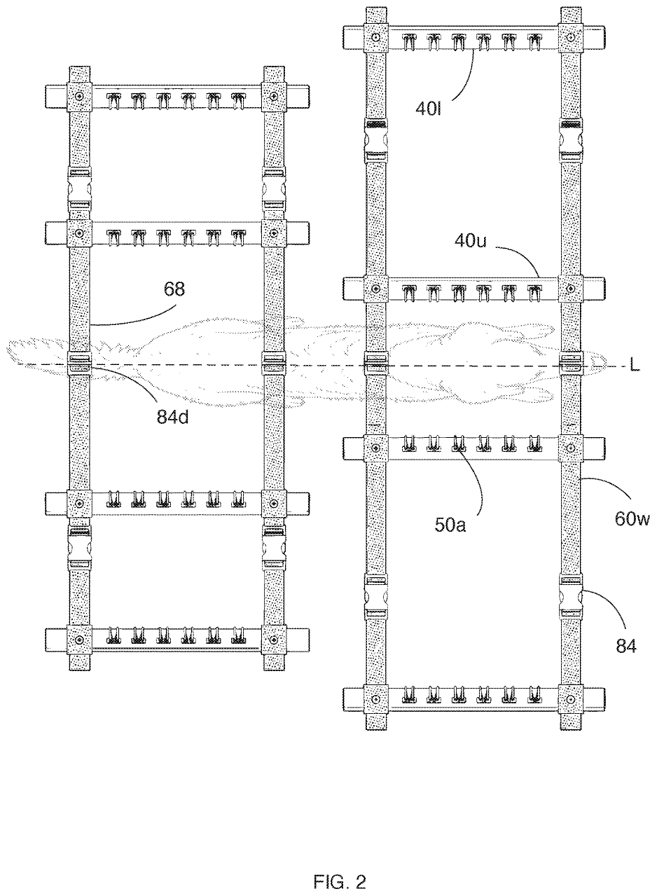

In a further embodiment, shown in FIG. 2, the opposing lateral regions of the harness 20 are interconnected by at least one adjustable dorsal cross-strap 68 extending over the dorsal region of the harness 20. The dorsal cross-strap 68 spans between the support structures 40 or harness attachment points on the first lateral region (lateral panel 24a) and the second lateral region (lateral panel 24b), passing over or along the dorsal panel 22 of the harness 20.

The dorsal cross-strap 68 is adjustable in effective length—meaning the functional distance between its two attachment points is selectable—by any suitable length-adjustment mechanism, including overlapping hook-and-loop fastening surfaces (adjustable by varying the extent of overlap between the two strap ends); mechanical slide buckles, cam buckles, or ratchet buckles (adjustable by feeding webbing through the buckle to a desired position); snap buttons or grommets at discrete positions along the strap; adjustable elastic bands; or other mechanisms that selectively vary the effective length of the cross-strap between its attachment points. In a preferred embodiment, the dorsal cross-strap 68 comprises a single mechanical buckle 84d positioned approximately at the center of the dorsal panel 22 over the animal's spine, with webbing extending from each side of the buckle 84d to the respective lateral attachment point on lateral panel 24a and lateral panel 24b, such that the lateral separation on each side may be independently adjusted by pulling or feeding the corresponding webbing length through the buckle 84d.

By decreasing the effective length of the dorsal cross-strap 68, the lateral separation between lateral panel 24a and lateral panel 24b is reduced, accommodating animals with narrower transverse body dimensions. By increasing the effective length, the lateral separation is increased, accommodating animals with wider transverse body dimensions. This lateral width adjustment operates independently of the vertical row spacing adjustment described in Section VII, enabling the system to be configured in two independent dimensions—vertical row spacing and lateral body width—to fit animals of varying body geometries without modifying the base harness 20 or the support structures 40.

In preferred embodiments, at least two dorsal cross-straps 68 are provided, positioned at different vertical heights corresponding to the upper and lower support structure levels, maintaining parallel alignment of the opposing lateral support structures 40 during lateral width adjustment. A single dorsal cross-strap 68 is equally effective for setting the lateral separation. The dorsal cross-strap 68 may be used in combination with any of the harness attachment mechanisms described above, including hook-and-loop straps 60, flexible straps 60w, and buckles 84.

In the laid-flat configuration shown in FIG. 2, the same assembly may also provide vertical adjustment along each lateral side of the animal-worn support structure. The upper support member 40u and lower support member 40l on a lateral side may be moved closer together or farther apart by repositioning the webbing straps 60w through corresponding mechanical buckles 84, thereby changing the vertical spacing between rows of engagement members 50a when the assembly is worn by the animal. The lateral adjustment provided by the dorsal cross-strap 68 and the vertical row-spacing adjustment provided by the webbing straps 60w and buckles 84 may be adjusted independently, allowing the assembly to accommodate both the transverse width of the animal's back and the vertical height or contour of each lateral side.

### IV. Container Engagement Members 50

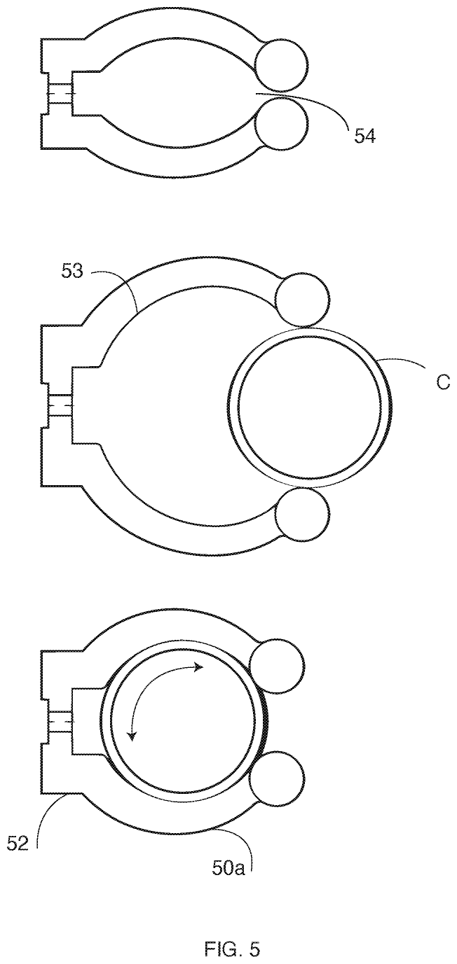

Referring to FIGS. 4-5, the container engagement members 50 are mounted to the support structure 40 and arranged along its length. Each container engagement member 50 is configured to releasably retain a portion of a container C in an exposed position. As used herein, “exposed position” means that at least a portion of the container C, when retained, is visible and manually graspable by a person approaching the animal A from the side, without requiring the person to open any pouch, pocket, flap, cover, closure, or enclosure. In preferred embodiments, labels, markings, branding, flavor indications, alcohol or non-alcohol indications, or other identifying information on the container C remain visible and readable to a person approaching the animal A, enabling the person to identify and select an individual container before withdrawal.

In some embodiments, the container engagement members 50 are mounted directly to the harness 20 or other animal-worn support structure without a separate rigid support member. For example, resilient engagement members 50a may be secured directly to reinforced fabric, webbing, straps, panels, loop surfaces, semi-rigid inserts, molded harness portions, saddle components, or pack panels. In such embodiments, the harness or saddle structure itself provides the support surface for the container engagement members 50.

The disclosed system encompasses two primary species of container engagement members 50, as well as combinations thereof.

### A. Species I—Resilient Engagement Member 50a

Referring to FIG. 5, the resilient engagement member 50a comprises a resilient body 52 defining an open gap 54 and a curved receiving region 53. The resilient body 52 is formed from a resilient material (e.g., thermoplastic elastomer, rubber, spring-steel wire, stamped spring steel, bent sheet metal, or another resilient material) and may define a partial annular, partial cylindrical, C-shaped, U-shaped, opposed-arm, saddle-clip, or other open resilient form. In certain embodiments, the open gap 54 is an open radial gap in a partial annular form, through which a cylindrical or generally cylindrical portion of a container C may be inserted radially.

Upon insertion of a portion of a container C through the open gap 54, the resilient body 52 flexes or deflects—i.e., the open gap 54 widens or the opposed portions of the resilient body 52 move apart to accommodate the container portion. Once the container portion is positioned within the curved receiving region, the resilient body 52 springs back or returns toward its natural state, partially encircling and releasably retaining the container portion. In the return/retention state, the resilient body 52 exerts an inward gripping force on an outer surface of the container C, thereby releasably retaining the container C. The container C may be retained with its neck, cap, shoulder, sidewall, body, tube portion, can wall, rounded portion, or other grippable portion engaged by the resilient body 52, leaving the remainder of the container visible and accessible.

A person may remove a retained container C from the resilient engagement member 50a by grasping the body of the container C and applying an upward, downward, lateral, twisting, or outward withdrawal force sufficient to overcome the gripping force of the resilient body 52, causing the resilient body 52 to flex open and release the container C. This selective individual removal may be performed without unfastening the harness 20 from the animal A and without disturbing adjacent engagement members 50 or their retained containers C. In certain embodiments, the retained container C may be manually rotated within the resilient engagement member 50a before withdrawal, allowing a person to inspect different sides of the container C, such as labels or markings. Such rotatability is an optional feature and is not required in all embodiments. In alternative embodiments, a friction-enhancing insert (e.g., rubber, silicone, or elastomeric material) may be disposed on the interior surface of the resilient body 52 to reduce or prevent rotation of a retained container C, as may be preferred for containers with smooth, uniform outer surfaces. After a container C has been withdrawn, the same resilient engagement member 50a may be reloaded with another container C by inserting a portion of the replacement container through the open gap 54. The resilient engagement member 50a is sized to accommodate the outer dimension of the target portion of the container C. For 50 mL liquor shooter bottles (approximately 28 mm outer diameter at the neck in some embodiments), the resilient body 52 in the relaxed state may have an internal dimension slightly smaller than the container neck diameter, ensuring positive retention. For beverage cans (approximately 66 mm outer diameter), a larger resilient body 52 with correspondingly larger internal dimension is provided. The system 10 may include resilient engagement members 50a of differing internal dimensions in the same array, enabling simultaneous retention of containers of different sizes or shapes.

In the preferred embodiment, the resilient engagement members 50a are commercially available flexible plastic clip components secured to the support structure 40 by mechanical fasteners (e.g., screws 56 driven through the support structure 40 from the interior face). The screws 56 prevent longitudinal sliding or rotation of the resilient engagement members 50a relative to the support structure 40.

In alternative embodiments, the resilient engagement members 50a may be formed integrally with the support structure 40 or directly with a harness or saddle component (e.g., by molding, casting, stitching, bonding, or 3D printing), or may be fabricated as wire-form clips, spring-steel clips, stamped metal clips, bent sheet-metal clips, molded resilient sockets, elastic loops, resilient clamps, or other resilient retention structures.

The engagement force of the resilient engagement member 50a is selected such that the container C is retained during normal movement of the animal A (including walking, trotting, and turning) but may be withdrawn by a person applying a normal manual withdrawal force. The engagement force is further selected such that, in the event of accidental excessive lateral impact (e.g., the animal brushing against furniture), the container C is released rather than causing the engagement member 50a to be torn from the support structure 40 or harness 20. This release-under-excessive-force characteristic is a safety feature of the disclosed system.

### B. Species II—Rigid Receptacle 50b

In alternative and complementary embodiments, the container engagement member 50 may comprise a rigid receptacle 50b—a cup, socket, channel, sleeve, open holder, or other receptacle sized to receive and retain at least a portion of a container C therein. The rigid receptacle 50b is formed from a rigid material (e.g., injection-molded polymer, aluminum, or 3D-printed resin) and defines an internal volume shaped to receive at least a portion of the body, base, neck, sidewall, or other portion of a container C. The container C is retained in the rigid receptacle 50b by gravity and/or a slight interference fit. The container C is removed by upward withdrawal or another manual withdrawal motion.

The rigid receptacle 50b differs from the resilient engagement member 50a in that it does not rely on elastic circumferential engagement; rather, it may provide an open-topped cup or channel that constrains the base and lower body of the container C. This embodiment is preferred for containers with smooth, uniform outer surfaces that do not have a suitable neck or cap feature for clip engagement.

### C. Mixed Arrays

In preferred embodiments, the system 10 includes both resilient engagement members 50a and rigid receptacles 50b in a mixed array mounted along a single support structure 40 or along one or more regions of the harness 20. This mixed configuration enables simultaneous retention of both shooter-style bottles (engaged by resilient members 50a at the neck, cap, shoulder, body, or another portion) and can-style containers (seated in rigid receptacles 50b).

A mixed array may include resilient engagement members 50a and rigid receptacles 50b arranged on the same support member 40, on different portions of the same lateral side of the animal-worn support structure 20, or on opposing lateral sides. For example, a single elongated support member 40 may carry one or more resilient engagement members 50a configured to releasably grip bottle necks, caps, shoulders, sidewalls, or tube portions, and one or more rigid receptacles 50b configured to receive bases, lower bodies, cans, cups, sample containers, or other container portions. The resilient engagement members 50a and rigid receptacles 50b may alternate, may be grouped by type, may be provided in different sizes, or may be selected according to the dimensions and withdrawal direction of the containers to be distributed.

### V. Row Configurations

### A. Two-row Configuration

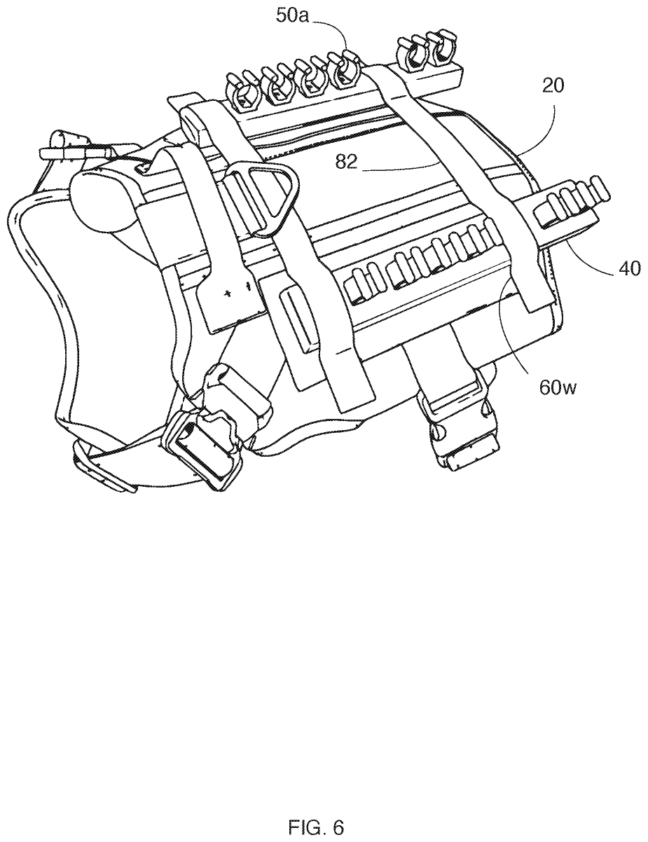

In the two-row configuration, shown in FIG. 6, each lateral side of the harness 20 carries a single support structure 40 with a linear array of container engagement members 50 mounted thereon. With support structures 40 on both lateral sides, the system 10 provides two rows of container engagement members 50 (one per side) extending along the animal's body.

In the preferred two-row embodiment, each support structure 40 carries six resilient engagement members 50a (one per approximately 1.5 inches of length for a 10-inch strip), providing a total of twelve containers C per two-row configuration. However, the number of container engagement members 50 mounted along each support structure 40 is scalable and depends on the dimensions of the specific animal, the size of the harness, and the desired container capacity. A support structure 40 may carry any number of container engagement members 50 from one to many, arranged at any spacing along its length.

### B. Four-row Configuration

In the four-row configuration, shown in FIGS. 1 and 3, each lateral side of the harness 20 carries two support structures 40: an upper support structure 40u and a lower support structure 40l. The upper and lower support structures 40u, 40l are vertically spaced from one another when the harness 20 is worn, positioning the engagement members of the upper row above those of the lower row. With upper and lower support structures on both lateral sides, the system 10 provides four rows of container engagement members 50.

In the preferred four-row embodiment, each support structure 40 carries six resilient engagement members 50a, providing a total of twenty-four containers C—the configuration depicted in the working prototype. As noted above, the number of engagement members per support structure is scalable; alternative four-row configurations may include fewer or more engagement members per side, depending on animal size and desired capacity.

### VI. Hybrid Rigid-flex Dorsal Support Assembly 70

Referring to FIG. 3, in the four-row configuration, the upper support structure 40u and the lower support structure 40l on each lateral side of the harness 20 are interconnected by at least one flexible coupling member 72, forming a unitary bilateral support assembly 70 for each lateral side. The flexible coupling member 72 is a strip or strap of flexible material (e.g., hook-and-loop strap, nylon webbing, or flexible polymer strip) that connects the upper and lower support structures while permitting relative flexion to conform to the contour of the animal's lateral body surface.

The hybrid rigid-flex dorsal support assembly 70 thus comprises alternating rigid or semi-rigid elements (the support structures 40u, 40l) and flexible elements (the flexible coupling members 72), providing a structure that is locally rigid or semi-rigid (supporting container arrays) but globally flexible (conforming to the animal's body). This architecture distributes load over a larger contact area than a single support structure, improving comfort for the animal and stability of the overall assembly.

In preferred embodiments, the upper and lower support structures 40u, 40l on each lateral side are themselves connected by a hook-and-loop strap sandwiching assembly—two parallel hook-and-loop straps flanking each support structure, pressed together so that the support structures are captured between the strap layers—providing the flexible coupling function while simultaneously serving as the harness attachment means.

### VII. Adjustable Lower Row Suspension 80

Referring generally to FIG. 2, in preferred embodiments, the lower support structure 40l is removably and adjustably suspended from the upper support structure 40u by an adjustable strap suspension mechanism 80.

The adjustable strap suspension mechanism 80 comprises at least one flexible suspension strap 82 and at least one mechanical buckle 84 configured to releasably lock the suspension strap 82 at a selected position. The suspension strap 82 is attached at a first end to the upper support structure 40u (e.g., via a loop, slot, or fastener in the support structure) and passes through the buckle 84, which is attached to or engaged with the lower support structure 40l. The free end of the suspension strap 82 passes back through the buckle 84 and is selectively secured (e.g., by a hook-and-loop keeper 86 that folds the strap end back against itself).

In some embodiments, each adjustable strap suspension mechanism 80 includes the flexible suspension strap 82 passing from the upper support member 40u toward the lower support member 40l, through or around the mechanical buckle 84, and back toward itself or toward an attachment region on the lower support member 40l. The mechanical buckle 84 may be a slide buckle, ladder-lock buckle, cam buckle, tri-glide buckle, ratchet buckle, side-release buckle with length-adjustment hardware, or other buckle that selectively grips or locks the flexible suspension strap 82 at a chosen strap length. The selected strap length sets the vertical spacing between the upper support member 40u and the lower support member 40l. The buckle 84 may be released, loosened, or actuated to permit the lower support member 40l and its carried engagement members 50 to be removed, exchanged, lowered, raised, or replaced without structurally modifying the animal-worn support structure 20.

The vertical position of the lower support structure 40l relative to the upper support structure 40u is adjusted by repositioning the suspension strap 82 through the buckle 84—pulling the strap through the buckle lowers the lower support structure; feeding strap back through the buckle raises it. This adjustment is tool-free and may be performed with one hand. In one preferred embodiment, the buckle 84 is a cam buckle or ladder lock buckle (also referred to as a double-end cam buckle or double-sided ladder lock buckle), which positively engages the webbing at any selected position and releases the webbing upon actuation of the cam or locking mechanism; however, any mechanical buckle capable of locking the webbing at a selected position without tools may be used.

In certain embodiments, a free end of the flexible suspension strap 82 is secured by a keeper 86 after adjustment. The keeper 86 may include hook-and-loop material, an elastic loop, a snap, a slide retainer, a sewn loop, a clip, a magnetic retainer, or another structure that holds the strap end against the strap or against the support member so that the free end does not dangle during use.

In preferred embodiments, at least two adjustable strap suspension mechanisms 80 are provided per side—one near each end of the lower support structure 40l—to maintain the lower support structure in a horizontal orientation and prevent tilting.

The lower support structure 40l may be selectively removed from the system 10 by disengaging the suspension straps 82 from the upper support structure 40u, thereby converting the system from a four-row to a two-row configuration without removing the harness 20 from the animal A. In the two-row configuration of FIG. 6, an adjustable suspension strap 82 may alternatively suspend a single support member 40 from the harness 20 directly, providing tool-free vertical height adjustment of the support member relative to the harness in the same manner.

### VIII. Stabilization and Safety Features

### A. Stabilization Pad 62

As noted above, a stabilization pad 62 of high-friction material may be disposed between the broad face 42 of the support structure 40 and the surface of the harness 20. The stabilization pad 62 increases friction, reducing the risk of the support structure 40 sliding laterally along the harness surface under the weight of the container array.

### B. Wrap Clamp Straps

In embodiments where additional anti-movement security is desired, one or more wrap clamp straps 90 may be provided. Each wrap clamp strap 90 encircles or partially encircles the support structure 40 and is secured to the harness 20 at one or both ends, preventing lateral displacement of the support structure 40 relative to the harness.

### C. Radiused Edges and Padding

The support structure 40 preferably has radiused or chamfered longitudinal edges 44. In embodiments intended for prolonged wear, a foam or elastomeric padding layer 92 is disposed between the support structure 40 and the animal's body (e.g., on the underside of the harness 20 beneath the support structure 40), providing comfort to the animal A.

### D. Overload Release

The engagement force of the resilient engagement members 50a is calibrated to permit container release under an excessive withdrawal force—for example, if a container C catches on an obstruction during normal animal movement. This prevents the container from causing the engagement member to be forcibly dislodged from the support structure 40, harness 20, saddle structure, or other animal-worn support structure, which could present a risk to the animal or bystanders.

### IX. Modular Decorative and Event Platform Features

The system 10 is designed for rapid reconfiguration between a container-serving mode and a decorative mode.

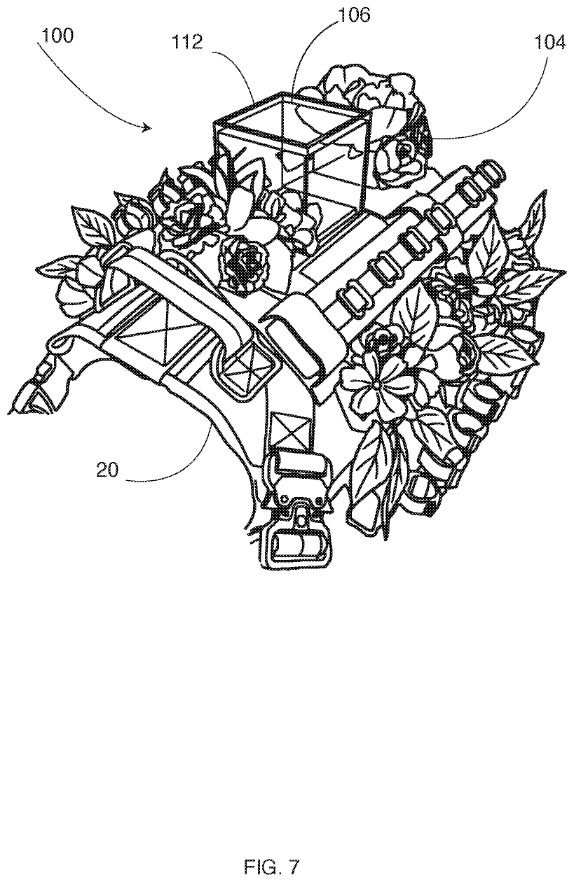

Referring to FIG. 7, in decorative mode, the container distribution assembly 30 (including support structures 40 and container engagement members 50) may be removed from the harness 20, and replaced with a decorative panel assembly 100 releasably attached to the hook-and-loop receiving surfaces 26 of the harness 20. The decorative panel assembly 100 may include any of the following:
Wedding panel 102: A decorative panel bearing floral motifs, ribbons, lace, or other wedding-themed ornamentation.
Floral integration panel 104: A panel with mounting channels or loops for securing artificial or real flowers in an arrangement on the animal's back or sides.
Branding surface 106: A panel bearing a sponsor logo, product name, or promotional message, suitable for events, trade shows, or brand activations.
LED integration panel 108: A panel incorporating LED lighting elements for evening events.
Ring bearer panel 110: A decorative cushion or box mount for carrying a wedding ring box on the animal's back.
Tip jar mount 112: A panel or backing assembly bearing a transparent collection container (e.g., a cylindrical or cuboidal tip jar) releasably attached via hook-and-loop fasteners to the dorsal panel 22 of the harness 20, enabling gratuities or voluntary contributions to be deposited by event attendees during container distribution service. The tip jar mount 112 occupies the dorsal hook-and-loop receiving surface 26 and is interchangeable with other modular panels without removing the harness 20 from the animal A.

Each decorative panel is releasably attached to the harness 20 via hook-and-loop fasteners, snap fasteners, buckles, clips, straps, magnetic fasteners, mechanical fasteners, or other releasable fastening structures, enabling rapid swap between container-serving and decorative configurations in the field.

The modular components may be provided as separate interchangeable modules, as a kit of modules, or as panels that attach to the same receiving surfaces used by the container distribution assembly. In some embodiments, a decorative panel assembly 100 includes one or more of a wedding panel 102, a floral integration panel 104, a branding surface 106, an LED integration panel 108, a ring bearer panel 110, and a tip jar mount 112. These modules may be attached individually or in combination, and may be exchanged with the container distribution assembly 30 or layered with portions of the container distribution assembly 30 while the animal-worn support structure 20 remains secured to the animal. A replacement engagement member assembly may include a support member 40 carrying engagement members 50 of a different size, shape, material, retention force, or container type than a previously attached assembly.

Each modular component may include a backing panel, strap, sleeve, tab, hook-and-loop region, snap, buckle, clip, magnetic region, latch, rail, slot, loop, adhesive region, or other attachment structure configured to releasably couple the modular component to the animal-worn support structure 20, to a support member 40, or to another modular component.

The container engagement members 50 themselves may be removably and interchangeably mounted to the support structures 40 or directly to the harness 20, enabling substitution of engagement members of different configurations (e.g., replacing clip members sized to retain 28 mm-diameter containers with cup members sized to receive 66 mm-diameter containers) for different container types.

### X. Example of Use—Wedding Event

In a preferred example of use, the system 10 is employed across multiple distinct phases of a wedding event. Critically, the wearable harness 20 remains secured to the animal A throughout all phases—the leash remains attached at all times and handler control is never interrupted. Only the modular attachment assemblies are exchanged between phases.

### Phase 1—Preparation

1. The harness 20 is fitted to the dog A before the event and adjusted for a comfortable, secure fit. A leash is attached to the harness 20 and remains attached for the duration of the event.

### Phase 2—Wedding Ceremony (Flower Girl and Ring Bearer)

2. A floral integration panel 104 bearing artificial flower arrangements and a ring bearer panel 110 carrying a wedding ring box are releasably attached to the hook-and-loop receiving surfaces 26 of the harness 20. The container distribution assembly 30 is not yet deployed.
3. The dog A is escorted down the aisle, serving simultaneously as flower girl and ring bearer. The leash remains attached to the harness 20 throughout, maintaining handler control in the presence of guests, music, and other ceremony distractions.

### Phase 3—Cocktail Hour (Container Distribution)

4. Following the ceremony, the handler removes the floral integration panel 104 and ring bearer panel 110 from the harness 20 and attaches the container distribution assembly 30—including four support structures 40 (two per side) carrying twenty-four resilient engagement members 50a in a four-row configuration—via hook-and-loop fastening straps 60. Optionally, a tip jar mount 112 is simultaneously attached via hook-and-loop fasteners to the dorsal panel 22 of the harness 20. The harness 20 is not removed from the dog A at any point during this transition.
5. Twenty-four 50 mL liquor shooter bottles C are individually loaded into the resilient engagement members 50a, each bottle snapping into retention as the resilient body 52 contracts around the bottle neck, cap, shoulder, body, or another grippable portion.
6. The dog A is escorted among cocktail-hour guests. Guests individually withdraw shooter bottles C by grasping the bottle body and pulling upward, without handler assistance. Guests may optionally deposit gratuities into the tip jar mount 112.
7. As containers are consumed, the handler reloads the engagement members 50a with fresh shooter bottles C without removing the harness 20 from the dog A.

### Phase 4—Evening Reception (LED Lighting)

8. As the event transitions to an evening or low-light environment, the handler attaches one or more LED integration panels 108 to the remaining available hook-and-loop surfaces of the harness 20, supplementing the existing container distribution assembly 30. The container distribution assembly 30 remains in place; the LED panels are added as an additional layer of modular decoration. No harness removal is required.
9. The dog A continues to circulate among reception guests with both the active shooter distribution system and the LED lighting display simultaneously deployed.

This example illustrates three key capabilities of the system 10: (a) rapid modular reconfiguration between distinct functional configurations without harness removal; (b) layered simultaneous deployment of multiple modular components; and (c) maintenance of continuous leash attachment and handler control throughout all configuration transitions—a critical safety feature in crowded, high-distraction event environments.

### XI. Alternative Embodiments

### A. Large Animal Embodiment

The system 10 is scalable to large animals including goats, miniature horses, donkeys, and full-sized horses. For larger animals, the support structures 40 are proportionally longer (e.g., 18-36 inches), carry larger arrays of container engagement members 50, and are secured to harnesses, saddles, saddle structures, saddle blankets, saddle rigging, packs, or other support structures appropriate for the animal species. The bilateral load distribution and adjustable strap suspension mechanisms operate identically.

### B. Integrated Molded Platform Embodiment

In an alternative embodiment, the rigid or semi-rigid support structure 40 and container engagement members 50 are formed as a single injection-molded, cast, or 3D-printed unitary platform, with engagement sockets integrally formed in the platform surface. The platform is attached to the harness 20 via hook-and-loop, snap, or buckle fasteners. This embodiment trades the modularity of the separate-component assembly for manufacturing simplicity and a streamlined appearance.

In an integral embodiment, the support member 40 and one or more container engagement members 50, including resilient engagement members 50a, are formed as a single continuous body of material. The continuous body may be injection molded, cast, 3D printed, thermoformed, machined, stamped, bent, overmolded, or otherwise manufactured so that at least a portion of each engagement member is non-separably joined with the support member. In cross-section, the material of the support member 40 may continue directly into the arms, base, bridge, or receiving region of the engagement member 50a, thereby forming a unitary support-and-retention structure. The integral unit may be attached to the animal-worn support structure 20 by hook-and-loop material, straps, buckles, snaps, fasteners, stitching, adhesive, or another attachment structure.

### C. Promotional and Commercial Distribution Embodiment

In a commercial embodiment, the system 10 is used at promotional events and brand activations. The support structures 40 carry branded rigid receptacles 50b, such as cups bearing a sponsor logo, loaded with promotional sample containers. The branding surface 106 decorative panel is simultaneously attached to the harness 20, providing 360-degree brand visibility as the animal A circulates among event attendees.

### XII. Advantages of the Invention

The disclosed systems and methods may provide one or more advantages relative to conventional harness-mounted pouches, saddlebags, utility packs, or enclosed carrier systems, including but not limited to the following:
1. Outwardly exposed selective access

Containers are retained in exposed positions in which at least a portion of each container is visible and manually graspable, thereby permitting direct visual identification and selective manual withdrawal of individual containers without opening flaps, covers, closures, zippers, pouches, pockets, or enclosed compartments. In certain embodiments, individual containers may be removed using a single hand without disturbing adjacent containers.
2. Improved load distribution and movement stability

Bilaterally positioned support structures distribute retained container weight across opposing lateral regions of the animal, thereby reducing localized loading and minimizing rotational shifting, swinging, or asymmetric loading during animal movement.
3. Conforming hybrid rigid-flex support architecture

In certain embodiments, vertically spaced support structures interconnected by flexible coupling members permit the assembly to conform to lateral body contours of the animal while maintaining sufficient rigidity to support retained containers in exposed positions.
4. Rapid reconfiguration and adjustability

Adjustable coupling structures, including hook-and-loop suspension members and adjustable slide hardware, permit selective repositioning of support structures and engagement-member rows without specialized tools. In certain embodiments, support assemblies may be removed, replaced, or reconfigured without removing the underlying harness from the animal.
5. Retention reliability with rapid extraction capability

Resilient engagement members provide partial encircling engagement and retention forces sufficient to resist unintended dislodgement during movement while still permitting intentional manual extraction of individual containers.
6. Modular functional interchangeability

The disclosed attachment architecture permits rapid interchange between container retention assemblies and alternative decorative or functional modules, including floral assemblies, ring-bearing structures, promotional displays, utility modules, or other event-specific accessories.
7. Animal safety and comfort

In certain embodiments, flexible attachment regions, rounded edges, releasable engagement structures, distributed load placement, and optional padding elements reduce concentrated pressure points and reduce interference with natural animal movement.
8. Species and scale adaptability

The disclosed systems may be scaled and adapted for use with differing animal species, body dimensions, harness geometries, and retained-container sizes while maintaining substantially similar operational principles.
9. Operational and commercial versatility

The disclosed systems may be adapted for beverage distribution, promotional item display, ceremonial use, branded marketing events, sample distribution, themed entertainment, utility transport, or other applications involving selective outward presentation and retrieval of containers or other items.
10. Continuous handler control during reconfiguration

Because the base harness remains secured to the animal throughout all modular configuration changes, the leash attachment point is never disconnected and handler control is never interrupted. This eliminates the escape risk inherent in prior art approaches that require complete harness removal to transition between configurations, and is particularly advantageous in crowded event environments—such as weddings, receptions, promotional gatherings, and parties—where environmental distractions are high and the consequence of an unrestrained animal is severe.

What is claimed is:

1. An animal-mounted container distribution system, comprising:
an animal-worn support structure configured to be secured to an animal, the animal-worn support structure comprising a wearable harness, saddle structure, saddle rigging, animal pack, vest, blanket, cape, or other structure wearable by the animal; and
a plurality of resilient engagement members mounted to the animal-worn support structure, each resilient engagement member comprising a resilient body defining an open gap and a curved receiving region;
wherein each resilient engagement member is configured to flex or deflect upon insertion of a portion of a container through the open gap and to spring back or return to partially encircle and releasably retain the portion of the container in an exposed position in which at least a portion of the container is visible and manually graspable without opening a flap, cover, closure, pouch, pocket, or enclosure;
whereby, after withdrawal of the container, the resilient engagement member can be reloaded with another container.

2. The system of claim 1, wherein a person can grasp and withdraw any individual container with a single hand without unfastening the animal-worn support structure, and without disturbing other containers.

3. The system of claim 1, wherein replacement containers can be inserted into the resilient engagement members with a single hand without unfastening the animal-worn support structure, and without disturbing other containers.

4. The system of claim 1, wherein each container can be positioned in the exposed position such that labels, markings, or identifying information on a surface of the container are visible and readable to a person approaching the animal to select and withdraw the container.

5. The system of claim 1, wherein each container is rotatable within the resilient engagement member such that a person can inspect all sides of the container before selecting and withdrawing it.

6. The system of claim 1, wherein the plurality of resilient engagement members are mounted along opposing first and second lateral regions of the animal-worn support structure, the first and second lateral regions being located on opposite sides of a longitudinal axis of the animal-worn support structure.

7. The system of claim 1, wherein the plurality of resilient engagement members includes engagement members having different internal dimensions, whereby the system is configured to releasably retain containers of differing outer dimensions.

8. The system of claim 1, wherein one or more modular components are releasably attachable to the animal-worn support structure, the one or more modular components including at least one of a decorative panel, a branding panel, a lighting module, a ring-bearing module, a floral module, or a replacement engagement member assembly.

9. An animal-mounted container distribution system comprising:
an animal-worn support structure configured to be secured to an animal, the animal-worn support structure comprising a wearable harness, saddle structure, saddle rigging, animal pack, vest, blanket, cape, or other structure wearable by the animal;
at least one rigid or semi-rigid support member secured to the animal-worn support structure by at least one fastener, the at least one fastener comprising a removable fastener, a permanent fastener, or a combination thereof; and
a plurality of container engagement members mounted to the at least one rigid or semi-rigid support member, each container engagement member configured to releasably retain a portion of a container in an exposed position in which at least a portion of the container is visible and manually graspable without opening a flap, cover, closure, pouch, pocket, or enclosure;
wherein the at least one rigid or semi-rigid support member is positionable along a lateral region of the animal-worn support structure in one or more vertically spaced rows to accommodate different animal sizes.

10. The system of claim 9, wherein the at least one rigid or semi-rigid support member comprises a first support member and a second support member, the first and second support members being vertically spaced from one another relative to a side surface of the animal-worn support structure, whereby the container engagement members are arranged in at least two vertically spaced rows.

11. The system of claim 10, wherein the vertical spacing between the first and second support members is adjustable.

12. The system of claim 10, wherein the first support member and the second support member are each secured to the animal-worn support structure by at least one flexible strap threaded through a mechanical buckle, the mechanical buckle configured to lock the flexible strap at a selected position that sets the vertical spacing between the first and second support members, and to release the flexible strap upon actuation to permit removal and exchange of the support member and its mounted engagement members without structural modification to the animal-worn support structure.

13. The system of claim 9, wherein the at least one rigid or semi-rigid support member is removably secured to the animal-worn support structure by one or more releasable attachment structures selected from hook-and-loop fasteners, straps, buckles, clips, snaps, latches, clamps, magnetic fasteners, interlocking rails, or combinations thereof.

14. The system of claim 9, wherein at least one of the plurality of container engagement members comprises a rigid receptacle configured to receive and retain at least a portion of the container therein.

15. The system of claim 14, wherein the system comprises both resilient engagement members and rigid receptacles, the resilient engagement members and rigid receptacles being arranged along the at least one rigid or semi-rigid support member in a mixed array.

16. The system of claim 9, wherein the at least one rigid or semi-rigid support member and the container engagement members are integrally molded or cast as a single non-separable unit.

17. The system of claim 9, wherein the at least one rigid or semi-rigid support member comprises:
a first pair of support members secured to a first lateral region of the animal-worn support structure, the first pair comprising a first upper support member and a first lower support member interconnected by at least one flexible coupling member; and
a second pair of support members secured to a second lateral region of the animal-worn support structure opposite the first lateral region, the second pair comprising a second upper support member and a second lower support member interconnected by at least one flexible coupling member.

18. The system of claim 9, further comprising at least one adjustable cross-strap extending over a dorsal region of the animal-worn support structure and spanning between opposing lateral regions of the animal-worn support structure, the at least one adjustable cross-strap being adjustable in effective length to selectively increase or decrease the lateral separation between the opposing lateral regions, whereby the system accommodates animals of differing transverse body widths.

19. A method of providing containers using an animal-mounted distribution system, the method comprising:
securing an animal-worn support structure to an animal;
attaching to the animal-worn support structure a container distribution assembly comprising a plurality of container engagement members configured to releasably retain portions of containers in exposed positions in which at least a portion of each container is visible and manually graspable without opening a flap, cover, closure, pouch, pocket, or enclosure;
retaining a plurality of containers in the container engagement members;
permitting individual containers to be manually withdrawn from respective container engagement members while the animal-worn support structure remains secured to the animal;
inserting replacement containers into emptied container engagement members; and
exchanging the container distribution assembly for a different container distribution assembly or a decorative or functional module while the animal-worn support structure remains secured to the animal.

20. The method of claim 19, wherein individual containers may be withdrawn from and inserted into the container engagement members with a single hand without unfastening the animal-worn support structure from the animal.
